(19) United States
(12) Patent Application Publication
(10) Pub. No.: US 2025/0127203 A1
(43) Pub. Date: Apr. 24, 2025

(54) SECONDARY MOLDING DEVICE FOR MEAT SUBSTITUTES

(71) Applicant: Sodick Co., Ltd., Kanagawa (JP)

(72) Inventors: Akinori NOGUCHI, Kanagawa (JP); Takeshi OKIYAMA, Kanagawa (JP); Eri NAKANO, Kanagawa (JP)

(73) Assignee: Sodick Co., Ltd., Kanagawa (JP)

(21) Appl. No.: 18/914,276

(22) Filed: Oct. 14, 2024

(30) Foreign Application Priority Data
Oct. 23, 2023 (JP) 2023-181651

(51) Int. Cl. A23P 30/10; A23J 3/22

(52) U.S. Cl. CPC A23P 30/10; A23J 3/227

(57) ABSTRACT

A secondary molding device for meat substitutes obtains a secondary molded product by heating a minced protein material in a pressurized state to bond protein components of the minced material and mold the same into a desired shape. The secondary molding device for meat substitutes includes a sealed pressurizing and heating chamber. The secondary molding device for meat substitutes includes a pressurizing device that pressurizes the minced material filled in a lower mold in the pressurizing and pressurizing and heating chamber at a predetermined pressure, and a high frequency power supply device that, within 300 seconds, supplies a high frequency current to the material in the pressurizing and heating chamber in accordance with the type of material to heat the material at a temperature of 110° C. or higher and 140° C. or lower.

### CROSS-REFERENCE TO RELATED APPLICATION

This application claims the priority benefits of Japanese application no. 2023-181651, filed on Oct. 23, 2023. The entity of the above-mentioned patent application is hereby incorporated by reference herein and made a part of this specification.

### BACKGROUND

### Technical Field

The disclosure relates to a device for producing meat substitutes. In particular, the disclosure relates to a secondary molding device for meat substitutes.

### Related Art

Technology for producing so-called meat substitutes, namely foods made from vegetarian or vegan ingredients that may be eaten instead of meat, is evolving year by year. Typical ingredients are wheat and soybeans. The market for meat substitutes, also known as artificial meat, fake meat or plant-based meat, is expanding. The protein material of the meat substitutes is minced into small pieces, and the minced material is solidified into a desired shape to produce a secondary molded product of meat substitutes. A twin-screw extruder is known as a device for producing protein materials. The twin-screw extruder extrudes the material containing required moisture through a die while applying pressure at a high temperature of over 100° C. Twin-screw extruders make it possible to produce material for meat substitutes continuously.

In a twin-screw extruder, the material itself acts as a seal to prevent the material from leaking out of the die due to the flow resistance that occurs at the die. Depending on the fluidity of the material or the shape or area of the die opening, the material may not be able to stay in the die and may be suddenly extruded. As a result, there is a risk that the material will not be molded properly and operation will have to be halted. As described above, in a twin-screw extruder, there are restrictions on the moisture content contained in the material, the shape of the die opening, and the area of the die opening.

In a twin-screw extruder, even if the material appears to be well molded, there is a risk that the internal structure of the material becomes spongy due to the swelling that occurs when the material is pressed out of the die and the moisture evaporates. As a result, the texture may deteriorate and the outer shape of the material may become distorted. Thus, in order to obtain the final secondary processed product, it is necessary to bond the material cut into granules again with a sub ingredient such as egg white as an adhesive.

For these reasons, there is a demand for technologies capable of converting protein materials into secondary processed products that exhibit structures and physical properties closer to those of real meat. Japanese Patent Laid-Open Publication No. 5-103593 and Japanese Patent No. 6649640 disclose a secondary molding device for meat substitutes that is capable of filling a metal mold with one or more types of soybean protein materials and heating and pressurizing the materials filled in the metal mold while adjusting the heating temperature and heating rate. The disclosed secondary molding device has fewer restrictions on the moisture content, shape and size of the secondary processed product compared to a twin-screw extruder, and can produce a greater variety of textured soybean protein foods with different textures.

There is room for improvement in the secondary molding device for meat substitutes. In particular, in order to obtain larger sized secondary molded products with better quality than ever before, regardless of the type of protein used as the material, the secondary molding device is required to satisfy at least the following conditions.

First, it allows for more precise and thorough consolidation of the minced material to better bond the proteins of the material together tightly. Secondly, even if the material has a relatively low thermal conductivity and requires a relatively long heating time, the interior of the material is heated to a predetermined temperature in the shortest possible time. Thirdly, a high-temperature heat treatment at over 100° C. is carried out with mainly moisture as a plasticizer co-existing with the material. Fourth, the secondary molded product after being heated and solidified is cooled in a shorter time and taken out.

The disclosure provides a secondary molding device for meat substitutes capable of better molding relatively large secondary molded products using moisture as a plasticizer, regardless of the origin of the material or the thermal history of the material. Here, the origin of the material refers to, for example, whether the main material is a vegetable food protein or an animal food protein. Moreover, the thermal history of the material refers to whether or not the protein material has already been heat-treated. Some advantages that can be obtained by the secondary molding device of the disclosure will be specifically shown in the description of the embodiments.

### SUMMARY

According to the disclosure, there is provided a secondary molding device for meat substitutes that obtains a secondary molded product by heating a minced protein material (MT) in a pressurized state to bond protein components of the minced material (MT) and mold the same into a desired shape. The secondary molding device includes a sealed pressurizing and heating chamber (1B), and includes a pressurizing device (3) that pressurizes the minced material (MT) filled between molds (8U, 8L) in the pressurizing and heating chamber (1B) at a predetermined pressure; and a high frequency power supply device (2) that, within 300 seconds, supplies a high frequency current to the material (MT) in the pressurizing and heating chamber (1B) in accordance with the type of the material (MT) to heat the material (MT) at a temperature of 110° C. or higher and 140° C. or lower.

### BRIEF DESCRIPTION OF THE DRAWINGS

FIG. 1 is a schematic view showing a first embodiment of a secondary molding device according to the disclosure.

FIG. 2 is a cross-sectional view showing a mold according to the first embodiment.

FIG. 3 is a schematic view showing a second embodiment of a secondary molding device according to the disclosure.

FIG. 4 is a cross-sectional view showing a mold according to the second embodiment.

FIG. 5 is a perspective view showing a lower mold in the secondary molding device of the disclosure.

FIG. 6A, FIG. 6B, and FIG. 6C are perspective views showing examples of a secondary molded product molded by the secondary molding device of the disclosure.

### DESCRIPTION OF THE EMBODIMENTS

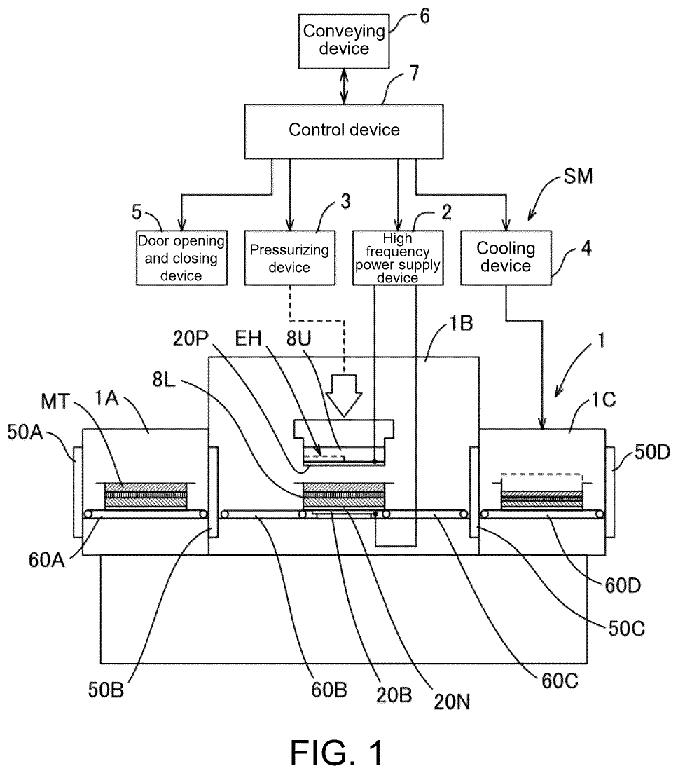

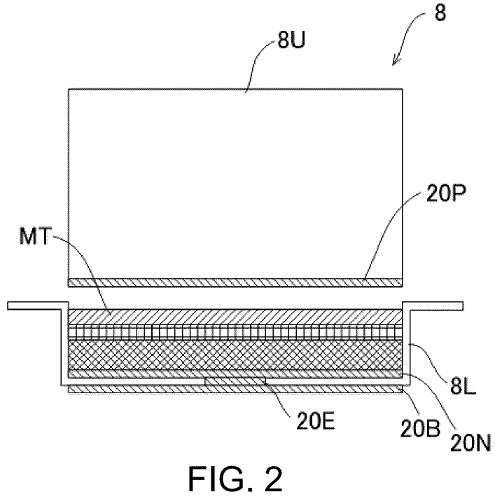

FIG. 1 is a schematic view showing a first embodiment of a secondary molding device for meat substitutes according to the disclosure. FIG. 2 shows a side view of a mold used in the secondary molding device shown in FIG. 1. The secondary molding device and mold shown in FIG. 1 and FIG. 2 are models and do not accurately reflect the actual secondary molding device and mold, and the relative positions and sizes of the multiple devices and components are not the same as in the actual ones.

The secondary molding device for meat substitutes shown in FIG. 1 performs secondary molding on the material by pressurizing and compressing the protein material for meat substitutes filled in a mold and heating it by electrical heating. Protein material may contain multiple additives. A secondary molding device SM shown in FIG. 1 includes a secondary molding device body 1, a high frequency power supply device 2, a pressurizing device 3, a cooling device 4, a door opening and closing device 5, a transport device 6, and a control device 7. The secondary molding device body 1 in the embodiment includes a pre-treatment chamber 1A, a pressurizing and heating chamber 1B, and a post-treatment chamber 1C.

The pre-treatment chamber 1A of the secondary molding device body 1 may be sealed by closing a door 50A. In the pre-treatment chamber 1A, one or more types of protein material MT for meat substitutes are filled into a concave part of a lower mold 8L. In FIG. 1 and FIG. 2, a plurality of types, for example, three types of protein materials are filled in layers. In the secondary molding device SM of the embodiment, an upper mold 8U has a convex shape that is the inverse of the concave shape of the lower mold 8L.

The pressurizing and heating chamber 1B in the secondary molding machine 1 has a structure that blocks high frequency electric current and electromagnetic waves. In the pressurizing and heating chamber 1B, the lower mold 8L filled with the material is fitted into the upper mold 8U attached to the pressurizing device 3. The lower mold 8L is positioned at a predetermined position where an electrode plate 20P provided on the upper mold 8U and another electrode plate 20N provided on the lower mold 8L are relatively aligned with each other. At a predetermined position, the material MT filled in the lower mold 8L is heated by the high frequency power supply device 2 while being pressurized by the upper mold 8U.

In the pressurizing and heating chamber 1B, the control device 7 operates the pressurizing device 3 to lower the upper mold 8U to a predetermined position where the material MT filled in the lower mold 8L is compressed with a predetermined pressure to the extent that the material MT adheres without gaps and moisture contained in the material MT does not leak out of the lower mold 8L. At this time, air is pushed out from the material MT, making it possible to sufficiently increase the thermal conductivity. The moisture contained in the material MT varies depending on the type, but is, for example, 60 weight %.

When the upper mold 8U compresses the material MT with a predetermined pressure, the electrode plate 20P provided on the upper mold 8U comes into even contact with the surface of the material MT. The control device 7 operates the high frequency power supply device 2 to supply a high frequency current to the material filled in the lower mold 8L, and heats the material MT from within the material MT by Joule heat at a temperature well above 100° C., preferably at a high temperature of 110° C. or higher. In the minced material MT that has been pressurized and heated, the protein components of adjacent pieces of material MT bond together and become integrated.

The heating time is short, within a short time of 300 seconds, in order to prevent deterioration of the material MT, such as liquefaction of the material MT. By shortening the heating time, the time required for cooling to 100° C. or less after heating can also be shortened. Preferably, steam generated between the upper mold 8U and the lower mold 8L during heating is exhausted to the outside through an exhaust pipe EH provided in the upper mold 8U. When the upper mold 8U includes the exhaust pipe EH, it is possible to prevent moisture from overflowing from the gap between the upper mold 8U and the lower mold 8L during heating.

The post-treatment chamber 1C of the secondary molding device body 1 of the embodiment protects the material MT from contact with the outside air, thereby retarding deterioration of the secondary molded product. The post-treatment chamber 1C also serves as a cooling chamber. The control device 7, for example, operates the cooling device 4 to cool the material to below 30° C. in a short time to prevent the growth of bacteria. In the post-treatment chamber 1C, the lower mold 8L may be inverted and the secondary molded product may be removed from the lower mold 8L. The secondary molded product released from the lower mold 8L falls freely in a recovery box (not shown) disposed at the lower side of the post-treatment chamber 1C or on a conveyor (not shown) and is recovered.

The high frequency power supply device 2 supplies a high frequency current between the electrode plate 20N provided on the lower mold 8L and the electrode plate 20P provided on the upper mold 8U shown in FIG. 2. The high frequency power supply device 2 preferably supplies a high frequency alternating current of 1 kHz or higher. The high frequency power supply device 2 of the embodiment may supply a high frequency alternating current of 20 kHz. However, the high frequency power supply device 2 of the embodiment may supply a low frequency alternating current depending on the type of the material MT, and may also perform electrical heating at a household power frequency of about 50 Hz, for example. The frequency of the high frequency power supply device 2 may be controlled by the control device 7.

The high frequency power supply device 2 includes a 100V or 200V direct current (DC) power supply. The direct current is converted into high frequency alternating current through a converter (not shown). The converter includes a bridge circuit of a plurality of switching elements such as metal-oxide-semiconductor field-effect transistors (MOSFETs). Alternatively, it may be configured to include a plurality of switching elements and a ferrite ring core.

The current is adjusted according to the material MT. In electrical heating, Joule heat is used for heating, so the current capable of completing heating at 110° C. or higher within 300 seconds may be calculated from the amount of power, voltage value, and resistance value in the electrical circuit including the material MT. Specifically, the current value may be determined by carrying out a test using a sample in advance in accordance with the type of the material MT and the shape and size of the secondary molded product, which are factors that affect the resistance value. The voltage and current in the high frequency power supply device 2 may be controlled by the control device 7.

The high frequency power supply device 2 in the secondary molding device SM of the embodiment supplies high frequency alternating current. Compared with electrical heating using direct current, electrical heating using high frequency alternating current is capable of reducing electrolytic corrosion of the pair of electrodes 20P, 20N, and therefore prevents metal contained in the electrodes from dissolving and becoming mixed into the material MT. In the high frequency power supply device 2, a metal that is resistant to electrolytic corrosion and has little effect on the human body, such as a titanium alloy, is selected as the material for the pair of electrodes 20P, 20N. Alternatively, metal such as nickel alloy that has relatively low electrolytic corrosion and little effect on the human body is selected. The secondary molding device of the embodiment promotes the widespread use of secondary molding of larger material by electrical heating, which has previously been difficult to put into practical use.

In this embodiment, the lower mold 8L is made of a heat-resistant resin suitable for food containers. When the lower mold 8L is made of resin, the loss of electric current may be reduced and the heating efficiency may be improved. Furthermore, the resin lower mold 8L has the advantage that contamination of the mold material due to electrolytic corrosion is less than that of a metal mold, and that it can be easily manufactured into any shape.

In the secondary molding device SM of the embodiment, the lower mold 8L is formed of a hard and durable resin having heat resistance that allows the outer shape to be maintained when being pressurized. However, this does not mean that a relatively soft resin such as silicon resin cannot be used as the material for the lower mold 8L. When the material of the lower mold 8L is a relatively soft resin, the outer periphery of the lower mold 8L may be reinforced with a stainless steel wall to prevent the lower mold 8L from deforming and spreading outward when pressure is applied at the pressurizing and heating position. When the lower mold 8L is made of a relatively soft resin, it is expected that the deformation of the lower mold 8L will have the effect of making it easier to release the secondary molded product.

The electrode plate 20N is provided on a bottom surface of the lower mold 8L. In the embodiment of the secondary molding device SM, a plurality of conductive materials 20E are provided on the bottom surface of the lower mold 8L; at a predetermined pressurizing and heating position in the chamber of the pressurizing and heating chamber 1B, a power feeding plate 20B and the electrode plate 20N, which are fixed to a pressurizing and heating position of the pressurizing and heating chamber 1B, are energized through the conductive materials 20E, and high frequency alternating current is supplied from a high frequency power supply device 2. At the pressurizing and heating position, the material MT filled in the lower mold 8L is electrically heated by high frequency alternating current while being pressurized by the upper mold 8U.

The pressurizing device 3 includes a driving device (not shown) that is a hydraulic cylinder or a linear motor and whose positioning may be controlled by a control device 7. Thus, the material MT is pressurized with a more suitable pressure. Delicate control over the movement of the upper mold 8U better prevents more moisture than necessary from leaking out of the material MT.

The upper mold 8U is replaceably attached to a moving body that is moved by a driving body in accordance with the outer shape and size of a desired secondary molded product. In the pressurizing device 3, after pressure is applied, the upper mold 8U rises together with the moving body. In the pressurizing device 3, when delicate pressurizing force and minute positioning in the height direction for the upper mold 8U are not required, for example, the material MT may be pressurized by the weight of the upper mold 8U alone. When the material MT is pressurized by the upper mold 8U alone, the upper mold 8U essentially constitutes the pressurizing device 3.

In the pressurizing device 3 of the embodiment, the upper mold 8U may be deformed so as to be removed from the moving body of the pressurizing device 3 after pressure is applied. When the upper mold 8U is removed from the moving body, as shown by the dotted line in FIG. 1, since the secondary molded product may be cooled in the post-treatment chamber 1C in a state where the upper mold 8U compresses the secondary molded product in the lower mold 8L with a pressurizing force of corresponding to its own weight, the secondary molded product can be better prevented from expanding.

Moreover, the next upper mold 8U need to be recovered from the post-treatment chamber 1C and reused, or the next upper mold 8U need to be prepared near the pressurizing and heating chamber 1B. Furthermore, in the disclosure, swelling may be prevented by applying pressure to the upper mold 8U by appropriately handling the steam or air generated during pressurization, or by keeping the internal pressure of the pressurizing and heating chamber 1B slightly higher than atmospheric pressure. The upper mold 8U is made of a material that is highly corrosion resistant, safe, relatively heavy, and easy to mold. Specifically, the upper mold 8U is made of, for example, iron whose surface is coated with a nickel alloy.

The pressurizing device 3 may apply pressure to the material MT by changing the pressure applied according to the type of the material MT using the control device 7. The pressurizing device 3 in the secondary molding device SM of the embodiment may pressurize the material MT up to a maximum of 0.5 MPa (approximately 5.1 kgf/cm²), for example. The required pressure is equal to or less than the pressure at which the material MT is sufficiently in close contact that moisture contained in the material MT does not leak out of the lower mold 8L.

The cooling device 4 supplies cold air, which has been cooled to a temperature equal to or lower than a predetermined temperature, to the post-treatment chamber 1C, thereby maintaining the temperature inside the chamber at or below the predetermined temperature. The cooling device 4 also jets and supplies cold air directly to the vicinity of the lower mold 8L, forcibly cooling the material MT in a short time. Alternatively, the cooling device 4 cools the secondary processed product in the lower mold 8L by directly injecting cold air thereto.

The cooling device 4 may be configured such that a cooling plate (not shown) is brought into contact with the surface of the material MT filled in the lower mold 8L to perform direct cooling. The cooling plate may, for example, have a configuration in which a plurality of cooling pipes are formed to supply a refrigerant, or may have a configuration including a plurality of Peltier elements. Moreover, the cooling device 4 may be configured to perform cooling with cooling water by either spraying it directly onto the lower mold or the secondary molded product, or by immersing the secondary molded product together with the lower mold 8L in cooling water stored in a cooling tank to directly cool the secondary molded product. The temperature of the water supplied from the cooling device 4 is equal to or lower than room temperature. When the secondary molded product is cooled by cooling water, the cooling time can be further shortened.

The door opening and closing device 5 operates doors 50A, 50B, 50C, and 50D that open and close the entrances to each of the pre-treatment chamber 1A, the pressurizing and heating chamber 1B, and the post-treatment chamber 1C of the secondary molding device body 1. The door opening and closing device 5 may be operated remotely by the control device 7. Moreover, the control device 7 may cause the door opening and closing device 5 perform sequential operations to automatically and continuously mold a plurality of materials MT.

The transport device 6 includes a conveyor 60A, a conveyor 60B, a conveyor 60C, a conveyor 60D, and a plurality of electric motors (not shown) that independently drive each conveyor. The conveyor is, for example, a belt conveyor or a roller conveyor. The transport device 6 is controlled by a control device 7. The control device 7 controls the driving of the electric motors and remotely and arbitrarily operates each conveyor, so as to automatically and continuously heat and pressurize the material MT.

The control device 7 may cause the high frequency power supply device 2, the pressurizing device 3, the cooling device 4, the door opening and closing device 5, and the transport device 6 to perform sequential operations independently. The control device 7 may control the operation of the high frequency power supply device 2, pressurizing device 3, cooling device 4, door opening and closing device 5, and the transport device 6 in conjunction with each other, and automatically and continuously fill the plurality of materials MT into the lower mold 8L, heat and pressurize them, cool them, and recover them.

The secondary molding device SM of the embodiment includes a pressurizing device 3 capable of pressurizing the material at any pressure using the control device 7, such that the material MT that has been minced may be sufficiently consolidated before being heated. Thus, the protein components of the material MT may be bonded more firmly and effectively, and a secondary molded product of meat substitutes with a better texture and a more satisfying bite may be obtained.

The secondary molding device SM includes a high frequency power supply device 2 that heats the material MT by electrical heating using high frequency alternating current, so even if the material MT is a type that has a relatively low thermal conductivity and requires a long time to heat, the material MT may be heated almost evenly to the inside at a high temperature of 110° C. or higher in a short time within 300 seconds. Thus, even if the protein material MT is larger in size than before, the material MT may be firmly and effectively bonded without any deterioration such as liquefaction, regardless of the origin of the material and the thermal history of the material, and a secondary molded product of meat substitutes with excellent quality can be obtained.

In the secondary molding device SM, the material MT is not kept at a high temperature for a long time due to the electrical heating by the high frequency power supply device 2, and therefore the time required for cooling is shorter than in the past. Thus, even if the material MT is of a relatively large size, a secondary molded product of good quality can be obtained. In particular, since the secondary molding device SM includes the cooling device 4, the secondary molded product can be rapidly cooled and removed in a shorter time.

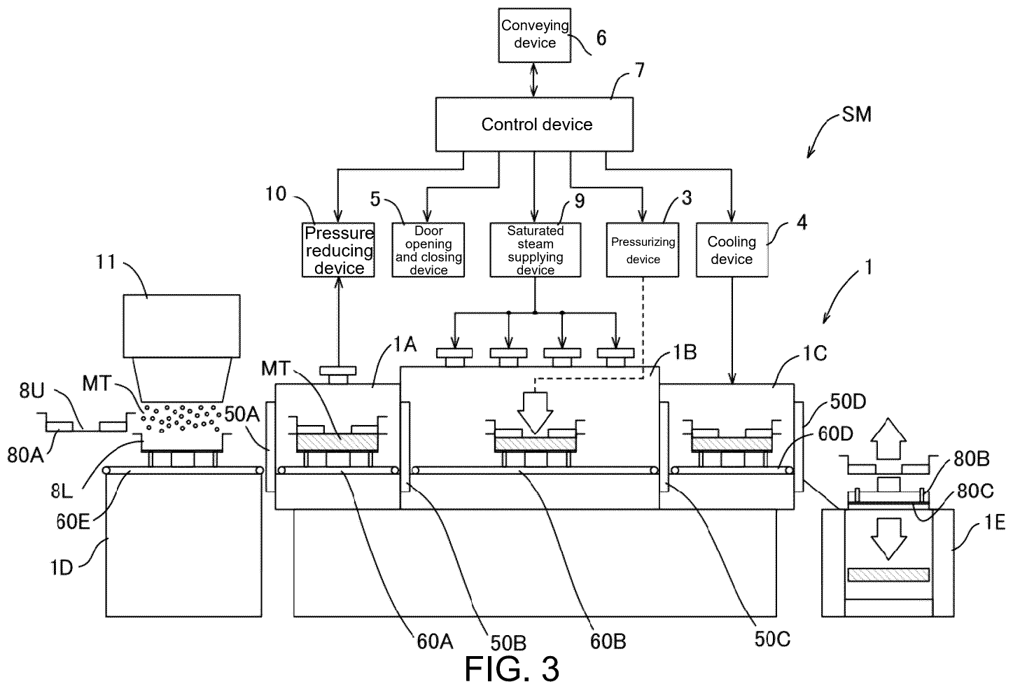

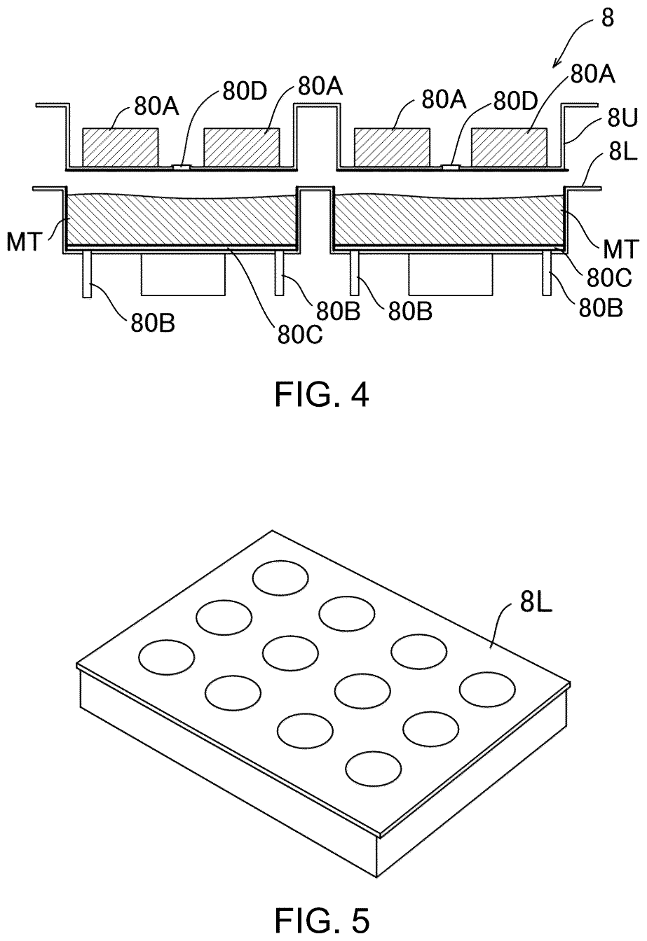

FIG. 3 is a schematic view showing a second embodiment of the secondary molding device for meat substitutes according to the disclosure. FIG. 4 shows a side view of a mold used in the secondary molding device shown in FIG. 3. The secondary molding device and mold shown in FIG. 3 and FIG. 4 are models and do not accurately reflect the actual secondary molding device and mold, and the relative positions and sizes of various devices and components are not the same as in the actual ones. In FIG. 3 and FIG. 4, when the same names as those of the secondary molding device and mold shown in FIG. 1 and FIG. 2 are used, the same reference numerals will be used for explanation even if the configuration or function is different.

The secondary molding device for meat substitutes shown in FIG. 3 pressurizes and compresses the protein material for meat substitutes filled in a mold, and heats it by a saturated steam heating method so as to perform secondary molding on the material. A plurality of additives may be added to the protein material. The secondary molding device SM shown in FIG. 3 includes at least a secondary molding device body 1, a pressurizing device 3, a door opening and closing device 5, a transport device 6, a control device 7, a saturated steam supplying device 9, and a pressure reducing device 10. The secondary molding device body 1 in the embodiment includes a pre-treatment chamber 1A, a pressurizing and heating chamber 1B, and a post-treatment chamber 1C. Moreover, the secondary molding device body 1 includes a material filling stage 1D and a metal mold recovery stage 1E.

The pre-treatment chamber 1A of the secondary molding device body 1 has a structure in which the interior may be sealed by closing the door 50A and the door 50B. In the secondary molding device SM of this embodiment, the pre-treatment chamber 1A is a pressure reducing chamber. The pre-treatment chamber 1A includes a plurality of sub-chambers corresponding to the required air pressure values, and the pressure may be reduced in stages to an air pressure of, for example, about 0.05 Pa, which is closer to a vacuum. Moreover, in order to prevent the pressure in the pressurizing and heating chamber 1B from rising suddenly from a low pressure environment, the pre-treatment chamber 1A may include a pressure restoration chamber in a sub-chamber adjacent to the pressurizing and heating chamber 1B among the plurality of sub-chambers and return pressure to atmospheric pressure.

Because air has a greater specific gravity than steam, when steam flows into a chamber, the air tends to stagnate at the bottom of the chamber rather than being discharged to the outside. Air has an insulating effect when heating the material MT, and therefore hinders the operation of raising the temperature to a predetermined temperature in a shorter time. By reducing the pressure in the pre-treatment chamber 1A, as much air as possible may be removed from the chamber, which helps to heat the relatively large material MT within the required short time.

The pressurizing and heating chamber 1B may be sealed by closing the door 50B and the door 50C. When the material MT is pressurized and heated, compressed and highly pressurized steam is rapidly supplied from the saturated steam supplying device 9 while the pressurizing and heating chamber 1B is kept sealed. At this time, when the material MT is exposed to high-temperature saturated steam for a long time, the proteins are hydrolyzed and liquefied. Thus, it is required to raise the temperature and heat the material MT to a predetermined temperature in a short time before it liquefies. Specifically, the temperature of the saturated steam supplied by the saturated steam supplying device 9 is 120° C. or more and 140° C. or less, and the heating time is 300 seconds or less.

The pressurizing device 3 is a device capable of operating without failure even in a hot and humid room. The pressurizing device 3 of the embodiment is not provided with a driving device, and is configured to apply pressure by a force obtained by adding the steam pressure of highly pressurized steam supplied into the pressurizing and heating chamber 1B acting in the direction of gravity to the pressure dependent on the weight of adding the mass of a deadweight 80A provided on the upper mold 8U to the mass of the upper mold 8U. Thus, in this embodiment, the pressurizing device 3 is substantially composed of the saturated steam supplying device 9 for supplying highly pressurized saturated steam and the upper mold 8U including the deadweight 80A.

The pressurizing device 3, which does not have a driving device, may obtain a sufficient pressurizing force for almost all types of material MT. However, depending on the type of material MT and the size of the upper mold 8U, such as in the case of a material MT that has a strong repulsive force, a high moisture content, and is relatively large, the pressurizing force may be insufficient using only the upper mold 8U including the deadweight 80A and the steam pressure. The pressurizing device 3 may be configured to include a pressing device such as a pusher (not shown) capable of operating in a high-temperature room, and the pusher may be used in combination as an auxiliary when the pressurizing force is insufficient.

An operator may set the temperature and time of the saturated steam to be supplied on the operation panel of the control device 7. The saturated steam supplying device 9 supplies high-temperature saturated steam at 120° C. or higher and 140° C. or lower for an appropriate time of 300 seconds or less according to the type of material MT and the size of the secondary molded product. The material MT in the lower mold 8L receives thermal energy from the condensation latent heat and sensible heat of steam generated on the surfaces of the upper mold 8U and the lower mold 8L, and is heated to the temperature of saturated steam in an extremely short time of less than one second.

The pressurized material MT is molded by obtaining thermoplasticity through thermal energy, with the moisture contained in the material MT and the steam condensed water generated on the surface of the material MT acting as a plasticizer. When there is sufficient moisture, the materials MT are better fused together due to the overall plasticity of the secondary molded product in which the materials MT are solidified. Furthermore, when the moisture is limited to water condensed on the surface of the secondary molded product, better molding is possible due to fusion between the materials MT on the outer surfaces of the materials MT and deformation due to softening of the materials MT.

In this way, when the material MT is heated by the saturated steam heating method, the material MT exhibits some fluidity according to the moisture content given to it. When the material MT has fluidity, there is a risk that the material MT may flow out from the gap between the upper mold 8U and the lower mold 8L. However, the material MT that is heated to an appropriate temperature for an appropriate time has sufficient viscoelasticity, and therefore the material MT does not leak out from the gap between the upper mold 8U and the lower mold 8L.

The post-treatment chamber 1C is a pressure restoration chamber for restoring the pressure in the upper mold 8U and the lower mold 8L to atmospheric pressure while the pressurizing and heating chamber 1B becomes high pressure during the pressurizing and heating treatment. The post-treatment chamber 1C also serves as a cooling chamber. When the pressure is restored in the pressure restoration chamber 1C, the air and steam inside the chamber are discharged and outside air or cold air is introduced into the post-treatment chamber 1C, whereby the secondary molded product is rapidly cooled through the molds 8U and 8L which have a relatively high thermal conductivity.

The material filling stage 1D is a worktable for filling the minced material MT from a material filling device 11 such as a hopper into the concave part of the lower mold 8L. In the material filling stage 1D, moisture may be supplied as a plasticizer as required. The moisture content in the material MT is accurately adjusted when water is added, and no variation in quality occurs among the plurality of secondary molded products that are continuously produced.

In the material filling stage 1D, the upper mold 8U including the deadweight 80A is placed on the lower mold 8L in a state aligned with the concave part filled with the material MT added with water. At this time, the material MT may drop to a certain height due to the weight of the upper mold 8U, which is the sum of the mass of the upper mold 8U and the mass of the deadweight 80A. However, since there is almost no gap between the upper mold 8U and the lower mold 8L and the moisture content contained in the material MT is adjusted, the material MT does not flow out from the gap.

The metal mold recovery stage 1E is a worktable for recovering the molds 8U and 8L. At the metal mold recovery stage 1E, the upper mold 8U is removed to the outside of the secondary molding device body 1 by a mold lifting device (not shown) and recovered. The lower mold 8L left on the table is turned over by an inversion device (not shown) such that the bottom surface faces up. At this time, a pin pressing device (not shown) pushes out a plurality of mold release extrusion pins 80B protruding from the bottom of the lower mold 8L, moving a movable plate 80C downward. As the movable plate 80C moves, the secondary molded product is released and falls freely, and then recovered by an appropriate method.

The door opening and closing device 5 operates the doors 50A, 50B, 50C, and 50D that open and close the entrances to each of the pre-treatment chamber 1A, the pressurizing and heating chamber 1B, and the post-treatment chamber 1C of the secondary molding device body 1. The door opening and closing device 5 may be operated remotely by the control device 7. Moreover, the control device 7 may cause the door opening and closing device 5 to perform sequential operations so as to automatically and continuously mold a plurality of materials MT.

The transport device 6 includes a conveyor 60A, a conveyor 60B, a conveyor 60D, and a conveyor 60E, and a plurality of electric motors (not shown) that independently drive each conveyor. The conveyor is, for example, a belt conveyor or a roller conveyor. The transport device 6 is controlled by a control device 7. The control device 7 controls the driving of the electric motors and remotely and arbitrarily operates each conveyor, so as to automatically and continuously heat and pressurize the material MT.

The saturated steam supplying device 9 includes a boiler and a compressor, not shown, and a plurality of supply pipes, and may supply high-pressure saturated steam compressed to a predetermined pressure to the pressurizing and heating chamber 1B. The saturated steam supplying device 9 may supply saturated steam at a temperature of 120° C. or higher and 140° C. or lower.

The pressure reducing device 10 includes a vacuum pump. When the pre-treatment chamber 1A has a plurality of sub-chambers corresponding to the air pressure values required, the pressure reducing device 10 may be provided with a vacuum pump in each sub-chamber, and the pressure may be reduced in stages to a low pressure close to vacuum. The pressure reducing device 10 in the secondary molding device SM of the embodiment is capable of reducing the air pressure in the pre-treatment chamber 1A to any desired pressure up to 0.05 Pa. Moreover, if necessary, the pressure in the sub-chamber adjacent to the pressurizing and heating chamber 1B may be restored to atmospheric pressure.

In the secondary molding device SM shown in FIG. 3, the cooling device 4 also serves as a pressure restoration device. The pressure restoration device opens a safety valve provided in the post-treatment chamber 1C to open the exhaust port, and restores the air pressure in the post-treatment chamber 1C that has been increased by the high-pressure saturated steam in the pressurizing and heating chamber 1B. The cooling device 4 supplies cold air ranging from room temperature air to about −10° C. to the post-treatment chamber 1C, and may constantly maintain the post-treatment chamber 1C at a predetermined temperature.

The cooling device 4 may directly inject and supply cold air or cooling water to the molds 8U and 8L, and may rapidly cool the secondary processed product molded in the pressurizing and heating chamber 1B. The cooling device 4 may be modified so as to directly cool the secondary processed products by immersing the secondary processed products together with the molds 8U and 8L in cooling water stored in a cooling tank. When the secondary processed product is directly cooled by cooling water, the secondary processed product may be cooled in a shorter time.

The control device 7 may cause the pressurizing device 3, the cooling device 4, the door opening and closing device 5, the transport device 6, the saturated steam supplying device 9, and the pressure reducing device 10 to perform sequential operations independently. The control device 7 may control the operation of the pressurizing device 3, the cooling device 4, the door opening and closing device 5, the transport device 6, the saturated steam supplying device 9, and the pressure reducing device 10 in conjunction with each other, and automatically and continuously fill the plurality of materials MT into the lower mold 8L, heat and pressurize them, cool them, and recover them.

In the saturated steam heating type secondary molding device SM, the molds 8U and 8L are metal molds. In particular, when the size of the molds 8U and 8L is large, in order to heat the material MT to a high temperature of 110° C. or higher and 140°° C. or lower in a short time within 300 seconds, it is desirable for the molds 8U and 8L to have high thermal conductivity.

As shown in FIG. 4, a lower mold 8L has a plurality of concave parts. For example, the concave parts of the lower mold 8L shown in FIG. 5 all have the same shape. At least the surface of the concave part of the lower mold 8L is coated with a material that does not easily dissolve in the material MT in order to prevent contamination caused by dissolving metal components contained in the metal mold.

For example, the concave part is coated with a fluororesin. Coating the concave parts with fluororesin suppresses contamination and prevents a decrease in the quality and safety of the secondary molded product. Coating the concave parts with fluororesin also improves the releasability of the secondary molded product and improves the efficiency of cleaning the lower mold 8L. Also, for example, the concave part is plated with a nickel alloy. Nickel alloy coating suppresses contamination, prevents deterioration of the quality and safety of the secondary molded product, and prevents a decrease in thermal conductivity.

The lower mold 8L includes the plurality of mold release extrusion pins 80B. The mold release extrusion pins 80B push out the metallic movable plate 80C that is disposed on the bottom surface of the concave part of the lower mold 8L, thereby facilitating the release of the secondary molded product. Originally, when the material MT is pressurized and heated in the pressurizing and heating chamber 1B of the main secondary molding device body 1, the moisture present between the lower mold 8L and the material MT evaporates, resulting in releasability. When the movable plate 80C is moved by the mold release extrusion pins 80B, the secondary molded product formed by solidifying the material MT may be lifted, such that the secondary molded product can be easily released from the lower mold 8L.

In the secondary molding device SM of the embodiment, the lower mold 8L is inverted in the metal mold recovery stage 1E to recover the secondary molded product. Thus, after the upper mold 8U moves to a position away from the metal mold recovery stage 1E, the mold release extrusion pin 80B is moved downward by an extrusion device (not shown) that is located above the mold release extrusion pin 80B. As a result, the secondary molded product is pushed out by the movable plate 80C and falls freely below the metal mold recovery stage 1E to be recovered. Further, when the lower mold 8L has the mold release extrusion pins 80B and the movable plate 80C, the secondary molded product may be recovered without inverting the lower mold 8L.

The upper mold 8U has a convex shape which is the inverse of the concave shape of the lower mold 8L. The convex part of the upper mold 8U fits into the concave part of the lower mold 8L with a small gap therebetween. At least the surface of the convex part of the upper mold 8U that comes into contact with the material MT is coated with, for example, a fluororesin or a nickel alloy.

The upper mold 8U in this embodiment includes one or more deadweights 80A for applying pressure. The upper mold 8U on which the deadweight 80A is provided is advantageous in that the mass of the deadweight 80A may be changed in accordance with the required pressurizing force. However, when the required pressurizing force is fixed, the required pressurizing force may be obtained by increasing the thickness of the convex part of upper mold 8U and thereby increasing the mass of upper mold 8U.

An air relief valve 80D is provided at the convex part of the upper mold 8U. When one upper mold 8U has a plurality of convex parts, the air relief valve 80D is provided at each of the convex parts. The air relief valve 80D exhausts air present in the concave part of the lower mold 8L from the concave part when the pressure is reduced in the pre-treatment chamber 1A of the secondary molding device body 1 in a state where the concave part of the lower mold 8L and the convex part of the upper mold 8U are engaged and the upper mold 8U is placed on the lower mold 8L. As a result, when performing pressurizing and heating treatment in the pressurizing and heating chamber 1B, the material MT may be heated in a state where the air having a heat insulating effect has been removed, making it possible to heat it at a high temperature in a shorter time.

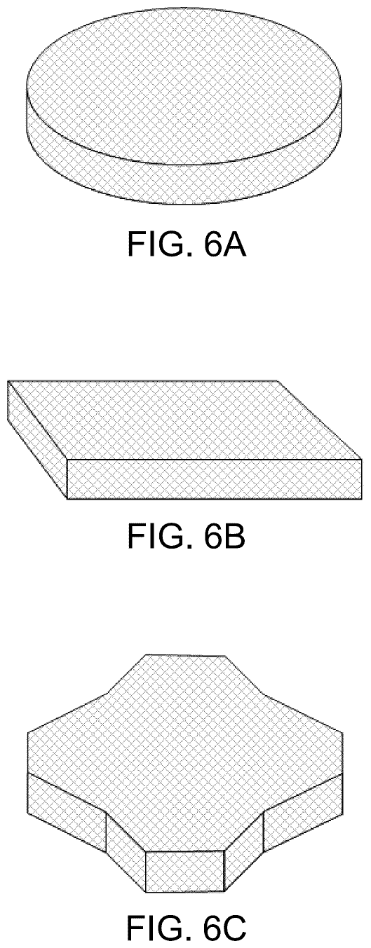

The secondary molding device for meat substitutes of the disclosure may produce secondary molded products using a lower mold 8L having a plurality of relatively large concave parts, as shown in FIG. 5, for example. This is advantageous in that more secondary molded products may be produced at one time. Further, for example, it is possible to produce a secondary molded product having a size larger than the disk shape shown in FIG. 6A or even the square shape shown in FIG. 6B that has been previously moldable. Furthermore, it is now possible to mold a secondary molded product having a complicated external shape as shown in FIG. 6C, which has been difficult to mold so far.

Using a relatively large metal mold having one circular concave part with a diameter of 30 cm and a depth of 10 cm, the soybean protein material is heated at 120° C. to 130° C. for 120 seconds by the secondary molding device SM shown in FIG. 3, and a disk-shaped secondary molded product with a diameter of 30 cm and a thickness of 10 cm is obtained. The protein in this secondary molded product has an adjusted orientation in the linear fiber direction, and the required strength and dense fiber structure can be maintained. The texture is less spongy than conventional products and has a chewy texture.

The saturated steam type secondary molding device SM vacuum-consolidates the material in the metal mold by reducing the pressure in the pre-treatment chamber 1A, and then heats it with saturated steam at a high pressure state capable of maintaining the saturated steam at a temperature of 110°° C. or higher and 140° C. or lower, using moisture as a plasticizer to utilize the thermoplasticity at the glass transition point. The thermal energy required to reach the glass transition point in a short time is supplied by the condensation latent heat of steam and the sensible heat of steam in the mold at the concave part having a relatively large area. Further, the consolidated state of the minced material is maintained by densification through reducing pressure or vacuum treatment in the pre-treatment chamber and by the pressure difference of saturated steam in the pressurizing and heating chamber.

By the close contact state between minced materials with each other, namely causing contact of the protein segments, while maintaining the thermoplasticity of the glass transition point, the structure of the minced materials is modified and they are molded into an integrated structure. Protein components undergo hydrolysis and liquefaction under high temperature conditions, but the secondary molding device SM may perform heating at a high temperature of 110° C. or higher and 140° C. or lower for a short time of less than 300 seconds, so hydrolysis or liquefaction of the protein components does not occur.

The disclosure is not limited to the embodiments described above. It is possible to modify the embodiments, replace the members, and combine the secondary molding device for meat substitutes of the disclosure with a known device without departing from the technical concept of the disclosure.

What is claimed is:

1. A secondary molding device for meat substitutes, obtaining a secondary molded product by heating a minced protein material in a pressurized state to bond protein components of the minced material and mold the same into a desired shape, the secondary molding device for meat substitutes comprising:
a sealed pressurizing and heating chamber;
a pressurizing device that pressurizes the minced material filled between an upper mold and a lower mold in the pressurizing and heating chamber at a predetermined pressure; and
a high frequency power supply device that, within 300 seconds, supplies a high frequency current to the material in the pressurizing and heating chamber in accordance with the type of the material to heat the material at a temperature of 110° C. or higher and 140° C. or lower.

2. The secondary molding device for meat substitutes according to claim 1, wherein the high frequency power supply device supplies a high frequency alternating current to the material.

3. The secondary molding device for meat substitutes according to claim 1, wherein the high frequency power supply device comprises a lower electrode plate provided on the lower mold into which the material is filled, and an upper electrode plate provided on the upper mold.

4. The secondary molding device for meat substitutes according to claim 1, comprising a sealed post-treatment chamber connected to the pressurizing and heating chamber, and a cooling device that cools in the post-treatment chamber the secondary molded product molded into the desired shape in the pressurizing and heating chamber.

5. The secondary molding device for meat substitutes according to claim 4, wherein the cooling device supplies cold air into the post-treatment chamber to cool the secondary molded product.

6. The secondary molding device for meat substitutes according to claim 4, wherein the cooling device cools the secondary molded product by bringing a cooling plate into contact with the secondary molded product in the post-treatment chamber.

7. The secondary molding device for meat substitutes according to claim 4, wherein the cooling device cools the secondary molded product by bringing cooling water into contact with the secondary molded product in the post-treatment chamber.

8. The secondary molding device for meat substitutes according to claim 1, wherein the lower mold into which the minced material is filled is made of resin.

9. A secondary molding device for meat substitutes, obtaining a secondary molded product by heating a minced protein material in a pressurized state to bond protein components of the minced material and mold the same into a desired shape, the secondary molding device for meat substitutes comprising: a sealed pre-treatment chamber; a sealed pressurizing and heating chamber; a pressure reducing device that reduces pressure inside the pre-treatment chamber while the material filled in a lower mold in the pre-treatment chamber is pressed by an upper mold opposed to the lower mold; a pressurizing device that pressurizes the material at a predetermined pressure in the sealed pressurizing and heating chamber; and a saturated steam supplying device that supplies saturated steam into the pressurizing and heating chamber and heats the material, while pressurized by the pressurizing device, at a temperature of 110° C. or higher and 140° C. or lower within a short time of 300 seconds in accordance with the type of material.

10. The secondary molding device for meat substitutes according to claim 9, wherein the pressurizing device obtains a pressurizing force for pressurizing the material by a pressure that depends on a mass of the upper mold and a pressure of the high-pressure saturated steam supplied from the saturated steam supplying device.

11. The secondary molding device for meat substitutes according to claim 10, wherein the saturated steam supplying device supplies a pressure required to increase an internal pressure of the pressurizing and heating chamber to a pressure necessary for the saturated steam to maintain a predetermined temperature.

12. The secondary molding device for meat substitutes according to claim 9, comprising a sealed post-treatment chamber connected to the pressurizing and heating chamber, and a cooling device that cools in the post-treatment chamber the secondary molded product molded into the desired shape in the pressurizing and heating chamber.

13. The secondary molding device for meat substitutes according to claim 12, wherein the cooling device supplies cold air into the post-treatment chamber to cool the secondary molded product.

14. The secondary molding device for meat substitutes according to claim 12, wherein the cooling device cools the secondary molded product by bringing cooling water into contact with the secondary molded product in the post-treatment chamber.

15. The secondary molding device for meat substitutes according to claim 9, wherein the upper mold comprises an air relief valve.
